(19) United States
(12) Patent Application Publication
(10) Pub. No.: US 2006/0095406 A1
(43) Pub. Date: May 4, 2006

(54) Displaying explain data for a SQL query of a database

(75) Inventors: Robert Joseph Bestgen, Dodge Center, MN (US); Shantan Kethireddy, Rochester, MN (US); Michael Donald Pfeifer, Rochester, MN (US)

Correspondence Address: IBM (ROC-BLF), C/O BIGGERS & OHANIAN, LLP, P.O. BOX 1469, AUSTIN, TX, 78767-1469, US

(73) Assignee: INTERNATIONAL BUSINESS MACHINES CORPORATION, ARMONK, NY (US)

(21) Appl. No.: 10/977,801

(22) Filed: Oct. 29, 2004

(51) Int. Cl. G06F 17/30

(52) U.S. Cl. 707/3

(57) ABSTRACT

Enabling a user to obtain and view graphic explain data with no need to activate a monitor and no need to wait for a job to complete before the explain data for a query may be viewed. Displaying explain data for an SQL query of a database that include executing an SQL query and displaying explain data for the SQL query while executing the SQL query. Displaying explain data includes identifying an access plan associated with the SQL query and generating explain data in dependence upon the access plan. Identifying an access plan may be carried out by retrieving an access plan identification from a cursor of a job control block and retrieving an access plan from an access plan cache in dependence upon the access plan identification.

### BACKGROUND OF THE INVENTION

1. Field of the Invention

The field of the invention is data processing, or, more specifically, methods, systems, and products for displaying explain data for an SQL query of a database.

2. Description of Related Art

The development of the EDVAC computer system of 1948 is often cited as the beginning of the computer era. Since that time, computer systems have evolved into extremely complicated devices. Today's computers are much more sophisticated than early systems such as the EDVAC. The most basic requirements levied upon computer systems, however, remain little changed. A computer system's job is to access, manipulate, and store information. Computer system designers are constantly striving to improve the way in which a computer system can deal with information.

Information stored on a computer system is often organized in a structure called a database. A database is a grouping of related structures called ‘tables,’ which in turn are organized in rows of individual data elements. The rows are often referred to a ‘records,’ and the individual data elements are referred to as ‘fields.’ In this specification generally, therefore, an aggregation of fields is referred to as a ‘data structure’ or a ‘record,’ and an aggregation of records is referred to as a ‘table.’ An aggregation of related tables is called a ‘database.’

A computer system typically operates according to computer program instructions in computer programs. A computer program that supports access to information in a database is typically called a database management system or a ‘DBMS.’ A DBMS is responsible for helping other computer programs access, manipulate, and save information in a database.

A DBMS typically supports access and management tools to aid users, developers, and other programs in accessing information in a database. One such tool is the structured query language, ‘SQL.’ SQL is query language for requesting information from a database. Although there is a standard of the American National Standards Institute (‘ANSI’) for SQL, as a practical matter, most versions of SQL tend to include many extensions. Here is an example of a database query expressed in SQL:
select * from stores, transactions
where stores.location=“Minnesota”
and stores.storeID=transactions.storeID

This SQL query accesses information in a database by selecting records from two tables of the database, one table named ‘stores’ and another table named ‘transactions.’ The records selected are those having value “Minnesota” in their store location fields and transactions for the stores in Minnesota. In retrieving the data for this SQL query, an SQL engine will first retrieve records from the stores table and then retrieve records from the transaction table. Records that satisfy the query requirements then are merged in a ‘join.’ These elements of the execution of the query, a retrieval from one table, then from another table, then a join, are referred to as an ‘access path.’

Database management tools are often implemented with screens of a graphical user interface, a ‘GUI.’ An example such a DBMS tool is a job management tool that displays explain data for a query. Explain data is data describing an access path for an SQL query. An example of a DBMS tool that displays explain data is IBM's Visual Explain, a database tool that graphically represents the implementation of a query request. Such tools provide a method of identifying and analyzing database performance problems. The implementation of a query is broken down into the individual element of an access path and organized in a tree structure. The resulting tree (made up of these base components) provides a visual explanation of the implementation of a query.

Such tools are useful to pinpoint the location of a performance defect. It is often the case that users will run multiple queries in a job where one or more of the queries run poorly. In order to identify performance defects, the user must first start a performance monitor and then run the entire job to completion. The monitor generates a monitor file which is then imported into a tool that lists the explainable queries that can be retrieved from the file. The user may select the worst running query and explain it. The design works well for identifying poorly running queries and explaining them. However, it does not work well in situations where the user has queries that are taking hours or days to complete. In these situations, the user must either wait for the job to end before the user can access the explain data from the monitor file. In addition, the user must have started the monitor before running the job; otherwise no explain data is available whatsoever.

### SUMMARY OF THE INVENTION

Methods, systems, and products are described in this specification that enable a user to obtain and view graphic explain data with no need to activate a monitor and no need to wait for a job to complete before the explain data for a query may be viewed. That is, exemplary methods, systems, and products are described for displaying explain data for an SQL query of a database that include executing an SQL query and displaying explain data for the SQL query while executing the SQL query. Executing the SQL query may include creating an access plan for the SQL query and executing primitive query functions in dependence upon the access plan. Creating the access plan may be carried out by parsing the SQL query and creating the access plan in dependence upon the parsed query. Creating the access plan may include optimizing the access plan in dependence upon database management statistics.

Displaying explain data may be carried out by identifying an access plan associated with the SQL query and generating explain data in dependence upon the access plan. Identifying an access plan may include retrieving an access plan identification from a cursor of a job control block and retrieving an access plan from an access plan cache in dependence upon the access plan identification. Generating explain data may be carried out by generating an intermediate representation of the access plan as intermediate explain data and generating a graphic representation of the access plan in dependence upon the intermediate explain data.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram of an exemplary system for displaying explain data for an SQL query of a database.

FIG. 2 sets forth a block diagram of automated computing machinery comprising a computer useful in displaying explain data for an SQL query of a database according to embodiments of the present invention.

FIG. 3 sets forth a flow chart illustrating an exemplary method for displaying explain data for an SQL query of a database.

FIG. 4 sets forth a flow chart illustrating an exemplary method for executing an SQL query.

FIG. 5 sets forth a flow chart illustrating an exemplary method for displaying explain data that includes identifying an access plan associated with the SQL query.

FIG. 6 sets forth an exemplary GUI display of a job operations management tool.

FIG. 7 sets forth an exemplary GUI display of graphic explain data for an SQL query.

FIG. 8 sets forth an exemplary listing of intermediate explain data.

### DETAILED DESCRIPTION OF EXEMPLARY EMBODIMENTS

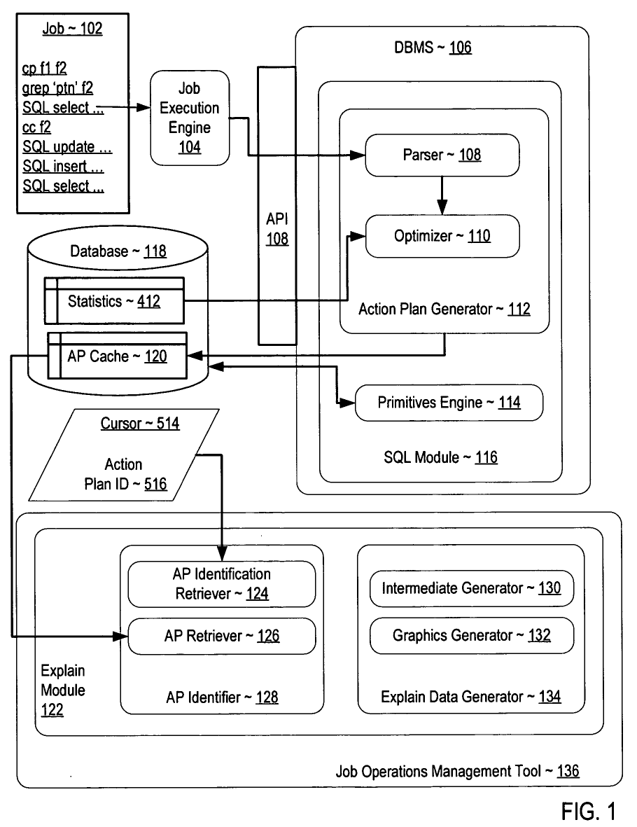

Exemplary methods, systems, and products for displaying explain data for an SQL query of a database are now described with reference to the accompanying drawings, beginning with FIG. 1. Each SQL query is carried out by a sequence of database operations specified as an access path. Explain data is data describing an access path for an SQL query. In this specification, explain data is represented in an intermediate form and in a graphic form, described in more detail below.

FIG. 1 sets forth a block diagram of an exemplary system for displaying explain data for an SQL query of a database. The exemplary system of FIG. 1 includes an SQL module (116). The SQL module is implemented as computer program instructions that execute an SQL query. In the example of FIG. 1, SQL module (116) receives SQL queries for execution from job execution engine (104). Job execution engine (104) is a software module that executes job, such as job (102), by passing commands from the jobs to software applications appropriate to the command. Jobs may mingle SQL queries with other commands to perform various data processing tasks. Job (102), for example, includes several commands for execution as part of job (102), including:
cp f1 f2: an operating system command to copy one file to another file.
grep ‘ptn’ f2: a general regular expression command of the operating system to find occurrences of ‘ptn’ in file f2,
cc f2: a command to compile file f2 as a C program, and
several SQL commands, each of which passes as a parameter to an executable command named ‘SQL’ call parameters identifying an SQL query.

In this example, job execution engine (104) will pass the operating system commands from job (102) to the operating system for execution and pass the SQL queries from job (102) to SQL module (116) for execution. Job execution engine (104) passes the SQL queries to SQL module (116) through application programming interface (‘API’) (108) of database management system (‘DBMS’) (106). DBMS (106) provides database management functions for database (118). DBMS (106) exposes API (108) to enable applications, including, for example, job execution engine (104) to access functions of the DBMS, including, for example, SQL module (116). The ‘SQL’ command illustrated in job (102) is a function made available through API (108).

The exemplary SQL module (116) of FIG. 1 includes an exemplary access plan generator (112). The access plan generator of FIG. 1 is implemented as computer program instructions that create an access plan for the SQL query. An access plan is a description of database functions for execution of an SQL query. Taking the following SQL query as an example:
select * from stores, transactions
where stores.storeID=transactions.storeID,
   access plan generator (112) may generate the following exemplary access plan:
tablescan stores
join to
index access of transactions

This access plan represents database functions to scan through the stores table and, for each stores record, join all transactions records for the store. The transactions for a store are identified through the storeID field acting as a foreign key. The fact that a selection of transactions records is carried out for each store record in the stores table identifies the join function as iterative.

The exemplary access plan generator (112) of FIG. 1 includes a parser (138) for parsing the SQL query. Parser (138) is implemented as computer program instructions that parse the SQL query. AN SQL query is presented to SQL module (116) in text form, the parameters of an SQL command. Parser (138) retrieves the elements of the SQL query from the text form of the query and places them in a data structure more useful for data processing of an SQL query by an SQL module.

The exemplary access plan generator (112) also includes an optimizer (110) implemented as computer program instructions that optimize the access plan in dependence upon database management statistics. Database statistics may reveal, for example, that there are only two storeID values in the transactions table—so that it is an optimization, that is, more efficient, to scan the transactions table rather than using an index. Alternatively, database statistics may reveal that there are many transaction records with only a few transactions records for each storeID—so that it is an optimization, that is, more efficient, to access the transactions records by an index. The exemplary SQL module (116) of FIG. 1 includes a primitives engine (114) implemented as computer program instructions that execute primitive query functions in dependence upon the access plan. A ‘primitive query function,’ or simply a ‘primitive,’ is a software function that carries out actual operations on a database, retrieving records from tables, inserting records into tables, deleting records from tables, updating records in tables, and so on. Primitives correspond to parts of an access plan and are identified in the access plan. Examples of primitives include the following database instructions:
retrieve the next three records from the stores table into hash table H1
retrieve one record from the transactions table into hash table H2
join the results of the previous two operations
store the result of the join in table T1

The exemplary system of FIG. 1 also includes an explain module (122), which in this example is implemented as computer program instructions that display explain data for the query while executing the query. Because the explain module (122) can display explain data for the query while the query is executing, there is no need for activation of a monitor or trace function before executing the query in order to make explain data available for display. In addition, there is no need to wait for execution of the query to complete before displaying explain data for the query.

The exemplary explain module (122) of FIG. 1 includes an access plan identifier (128), which is implemented as computer program instructions that identify an access plan associated with the query. The exemplary access plan identifier (128) of FIG. 1 includes an access plan identification retriever (124) implemented as computer program instructions that retrieve an access plan identification (516) from a cursor (514) of a job control block. A job control block (not shown on FIG. 1) is a data structure representing a job in an operating system. The job control block is a useful place to store job-related data including, for example, access plan identification codes and cursors. A ‘cursor’ is a data structure whose data elements describe or identify the primitives of an access plan for an SQL query. The exemplary access plan identifier of FIG. 1 also includes an access plan retriever (126), which is implemented in this example as computer program instructions that retrieve an access plan from an access plan cache (120) in dependence upon the access plan identification (516).

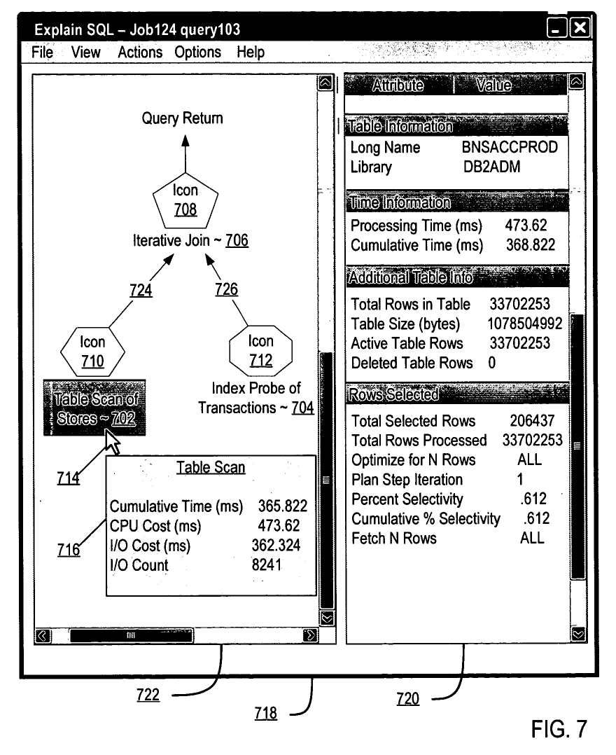

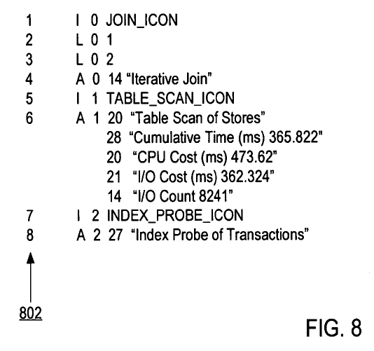

The exemplary explain module (122) of FIG. 1 also includes an explain data generator (134) implemented as computer program instructions that generate explain data in dependence upon the access plan. The exemplary explain data generator (134) of FIG. 1 includes an intermediate generator (130) implemented as computer program instructions that generate an intermediate representation of the access plan as intermediate explain data. Intermediate explain data is a non-visual encoding of an access path for an SQL query for use in creating a visual representation, including indications of which icons to use in a graphic depiction of the path, links among path elements, and attributes of display elements. Intermediate explain data is described in more detail below with reference to FIG. 8. The exemplary explain data generator (134) of FIG. 1 also includes a graphics generator (132) implemented as computer program instructions that generate a graphic representation of the access plan in dependence upon the intermediate explain data. Graphic representation of the access plan includes icons, connectors, or arrows indicating access path, and explanatory text for screen display. Graphic representation of the access plan is explained in more detail below with reference to FIG. 7.

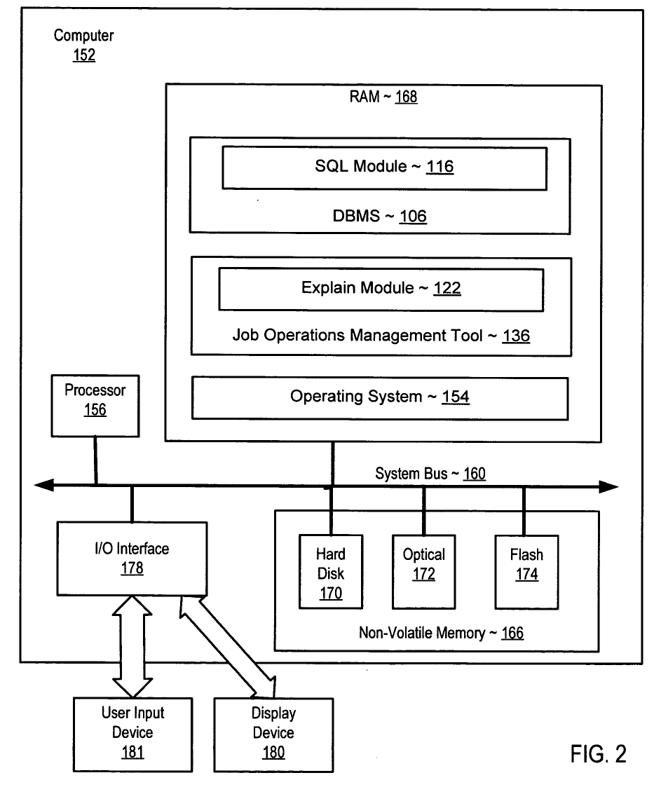

As mentioned above, displaying explain data for an SQL query of a database in accordance with the present invention is generally implemented with computers, that is, with automated computing machinery. For further explanation, FIG. 2 sets forth a block diagram of automated computing machinery comprising a computer (152) useful in displaying explain data for an SQL query of a database according to embodiments of the present invention. The computer (152) of FIG. 2 includes at least one computer processor (156) or ‘CPU’ as well as random access memory (168) (“RAM”). Stored in RAM (168) is database management system (106) and a job operations management tool (136). The database management system (106) of FIG. 2 includes an SQL module (116), which in turn includes an access plan generator and a primitives engine as described above. The job operations management tool of FIG. 2 includes an explain module (122) which in turn includes an access plan identifier and an explain data generator as described above.

Also stored in RAM (168) is an operating system (154). Operating systems useful in computers according to embodiments of the present invention include Unix, Linux, Microsoft NT™, i50S, and many others as will occur to those of skill in the art. Operating system (154), DBMS (106), and job operations management tool (136) in the example of FIG. 2 are shown in RAM (154), but many components of such software typically are stored in non-volatile memory (166) also.

The computer (152) of FIG. 2 includes non-volatile computer memory (166) coupled through a system bus (160) to processor (156) and to other components of the computer. Non-volatile computer memory (166) may be implemented as a hard disk drive (170), optical disk drive (172), electrically erasable programmable read-only memory space (so-called ‘EEPROM’ or ‘Flash’ memory) (174), RAM drives (not shown), or as any other kind of computer memory as will occur to those of skill in the art.

The example computer of FIG. 2 includes one or more input/output interface adapters (178). Input/output interface adapters in computers implement user-oriented input/output through, for example, software drivers and computer hardware for controlling output to display devices (180) such as computer display screens, as well as user input from user input devices (181) such as keyboards and mice.

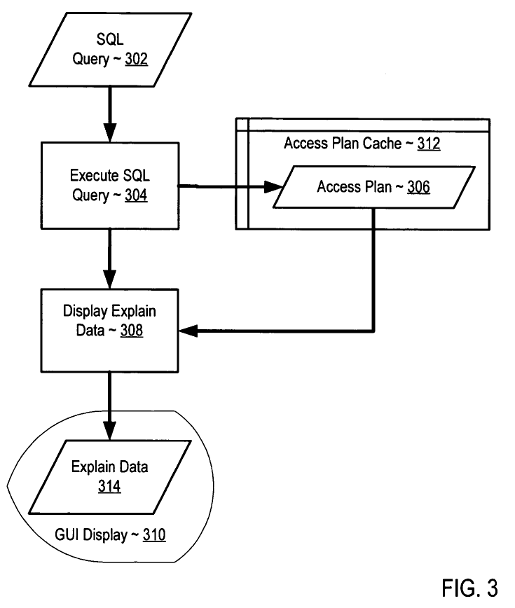

For further explanation, FIG. 3 sets forth a flow chart illustrating an exemplary method for displaying explain data for an SQL query of a database. The method of FIG. 3 includes executing (304) an SQL query (302) and displaying (308) explain data (314) for the SQL query (302) while executing the SQL query (302). Executing (304) an SQL query includes generating an access plan (306), which in this example is stored in an access plan cache (312). The access plan cache (312) is computer memory dedicated to storage of access plans. Displaying (308) explain data (314) for the SQL query (302) is carried out by generating explain data (314) from the access plan, and the explain data (314) is displayed on GUI display (310).

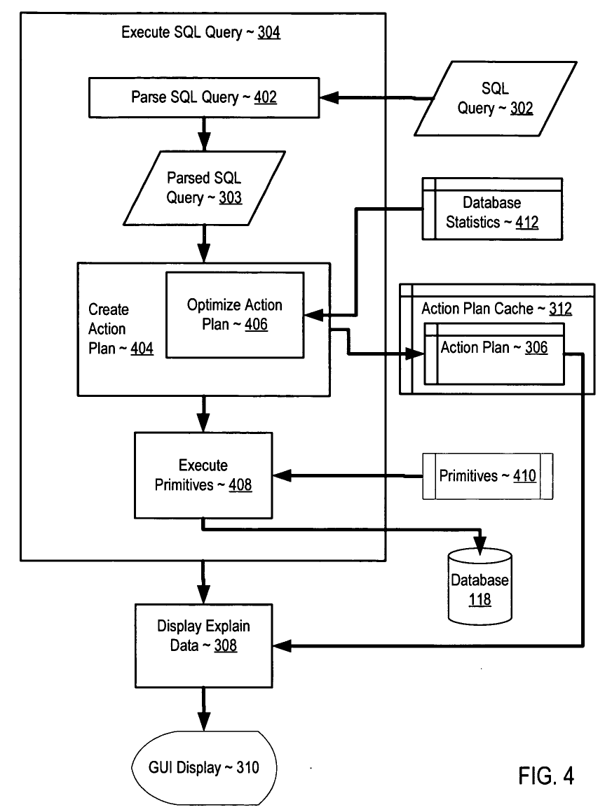

For further explanation, FIG. 4 sets forth a flow chart illustrating an exemplary method for executing (304) an SQL query (302). The method of FIG. 4 includes parsing (402) the SQL query (302) and creating (404) an access plan (306) in dependence upon the parsed query (303). As discussed above, parsing (402) the SQL query (302) includes receiving the parameters of an SQL command in text form, retrieving the parameters from the text form of the query, and placing the parameters in a data structure more useful for data processing of an SQL query by an SQL module.

In the method of FIG. 4, creating (404) the access plan (306) also includes optimizing (406) the access plan in dependence upon database management statistics (412). As discussed above, database management statistics may reveal information about the database useful in creating an efficient access plan.

The method of FIG. 4 also includes executing (408) primitive query functions (410) in dependence upon the access plan (306) to carry out actual database operations on database (118). As discussed above, a ‘primitive query function,’ or simply a ‘primitive,’ is a software function that carries out actual operations on a database, retrieving records from tables, inserting records into tables, deleting records from tables, updating records in tables, and so on. Primitives correspond to parts of an access plan and are identified in the access plan.

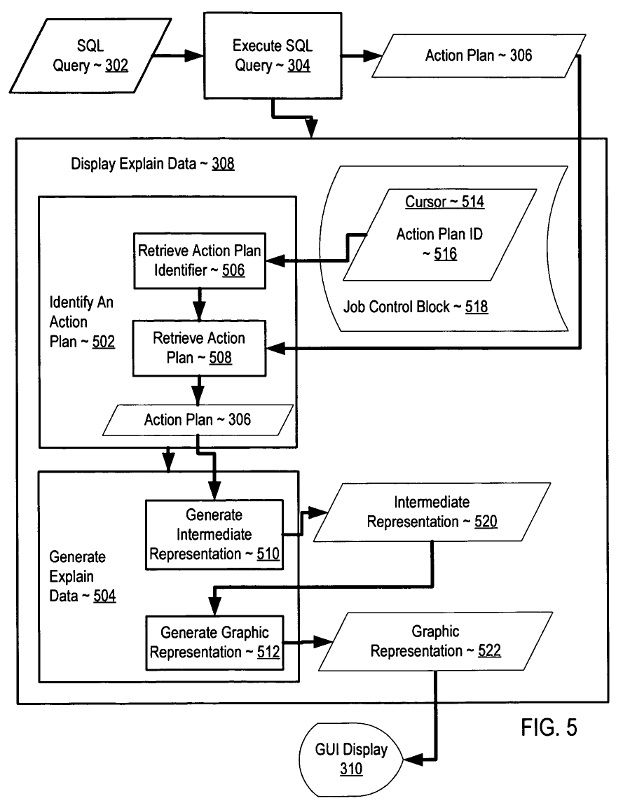

For further explanation, FIG. 5 sets forth a flow chart illustrating an exemplary method for displaying (308) explain data that includes identifying (502) an access plan (306) associated with the SQL query (302). In the method of FIG. 5, identifying (502) an access plan (306) is carried out by retrieving (506) an access plan identification (516) from a cursor (514) of a job control block (518) and retrieving (508) an access plan (306) from an access plan cache in dependence upon the access plan identification (516). As mentioned above, a job control block (518) is a data structure representing a job in an operating system. The job control block is a useful place to store job-related data including, for example, access plan identification codes and cursors. A cursor (514) is a data structure whose data elements describe or identify the primitives of an access plan for an SQL query. Retrieving (508) an access plan (306) from an access plan cache in dependence upon the access plan identification (516) is typically carried out by an access plan retriever, which is implemented as computer program instructions that retrieve an access plan from an access plan cache (120) in dependence upon the access plan identification (516).

The method of FIG. 5 also includes generating (504) explain data in dependence upon the access plan (306). In the method of FIG. 5, generating (504) explain data is carried out by generating (510) an intermediate representation (520) of the access plan (306) as intermediate explain data and generating (512) a graphic representation (522) of the access plan (306) in dependence upon the intermediate explain data (520). As discussed above, intermediate explain data is a non-visual encoding of an access path for an SQL query for use in creating a visual representation, including indications of which icons to use in a graphic depiction of the path, links among path elements, and attributes of display elements. Generating (510) an intermediate representation (520) of the access plan (306) as intermediate explain data is typically carried out by an intermediate generator (130) implemented as computer program instructions that generate an intermediate representation of the access plan as intermediate explain data. Graphic representation of the access plan includes icons, connectors or arrows indicating access path, and explanatory text for screen display and generating (512) a graphic representation (522) of the access plan (306) is typically carried out by a graphics generator (132) implemented as computer program instructions that generate a graphic representation of the access plan in dependence upon the intermediate explain data.

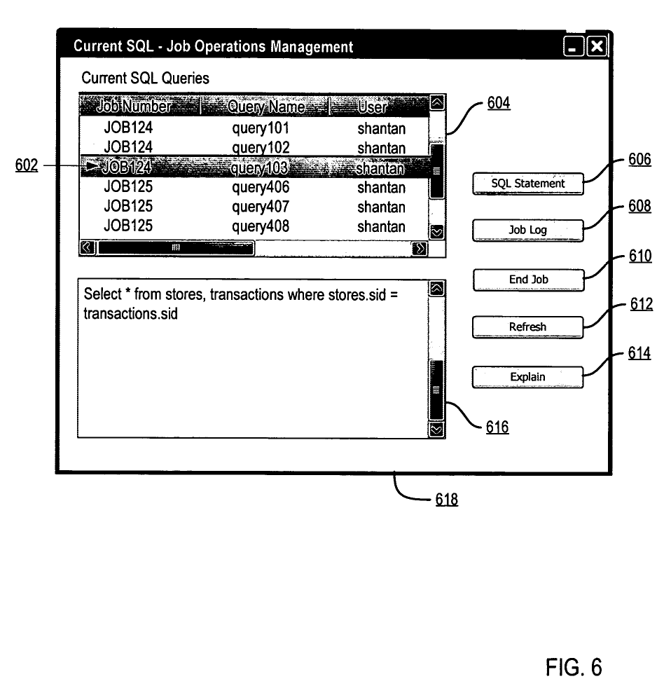

For further explanation, FIG. 6 sets forth an exemplary GUI display (618) of a job operations management tool (136 on FIG. 1). The exemplary display of FIG. 6 includes a text box (604) in which are displayed data records representing SQL queries in jobs. Each record displayed in text box (604) includes a job number of the job in which an SQL query is included, a name of an SQL query, an user identification of a user who ordered the job. The inclusion of these three data elements in the query records of text box (604) is for explanation, not a limitation of the invention. In fact, such a scroll of data may include any descriptive data elements for SQL queries in jobs as will occur to those of skill in the art.

The exemplary display (618) of FIG. 6 includes GUI controls to display a job log (608), end a job (610), and refresh the display (612). In addition, the exemplary display (618) of FIG. 6 includes a GUI button (606) labeled “SQL Statement,” which when invoked causes the display in text box (616) of the text form of the SQL query currently selected in text box (604). In this example, SQL query (602) is selected in text box (604), and the text form of the SQL query is displayed in text box (616), that is:
select * from stores, transactions
where stores.storeID=transactions.storeID.

The exemplary display (618) of FIG. 6 also includes a GUI button (614) to display graphic explain data for the SQL query currently selected (602) in text box (604). That is, in this example, invoking button (614) generates the display illustrated in FIG. 7.

FIG. 7 sets forth an exemplary GUI display (718) of graphic explain data for an SQL query. Each SQL query is carried out by a sequence of database operations specified as an access path. Explain data is data describing an access path for an SQL query. The example of FIG. 7 illustrates an access path for an SQL query as a tree structure implemented with graphic explain data. In particular, the example of FIG. 7 illustrates graphic explain data for the selected SQL query (602) from text box (604) from the GUI display of FIG. 6. The graphic explain data illustrated in FIG. 7 is derived from an access plan generated to support execution of the pertinent SQL query, that is:
tablescan stores
join to
index access of transactions

In the example of FIG. 7, icon (710) is graphic explain data representing the scan of the stores table from the first line of the access plan. The display text (702) is additional explain data representing the tablescan of stores. The display area for the tablescan is selected by use of mousepointer (714). All the information in text box (720) is explain data for the tablescan of stores displayed in response to the selection of the display area for the tablescan of stores. While the mousepointer is over the display area for the tablescan, additional explain data in the form of tooltip text (716) is displayed for the tablescan of stores. The particular information displayed as tooltip text or explain text in text box (720) is for explanation only, not for limitation of the invention. The display of any explain text as will occur to those of skill in the art is well within the scope of the present invention.

Icon (712) is graphic explain data representing the index access of the transactions table from the third line of the access plan. The display text (704) is additional explain data representing the index access of the transactions table. Icon (708) is graphic explain data representing the join of the results of the scan of the stores table from the first line of the access plan and the index access of the transactions table from the third line of the access plan. The display text (706) is additional explain data representing the join from the second line of the access plan. The arrows (724, 726) are graphic explain data representing the links among elements in the illustrated access path, forming a tree structure as mentioned above.

The graphic explain data illustrated in FIG. 7 may be generated in dependence upon intermediate explain data. Graphic representation of the access plan, as shown in FIG. 7, includes icons, connectors, or arrows indicating access path, and explanatory text for screen display. Intermediate explain data is a non-visual encoding of an access path for an SQL query for use in creating a visual representation, including indications of which icons to use in a graphic depiction of the path, links among path elements, and attributes of display elements. Icons and other graphic elements are relatively heavy weight in terms of computer resource utilization. Intermediate explain data advantageously provides a way to move explain data among functional modules of a system in compact form.

For further explanation of intermediate explain data, FIG. 8 sets forth an exemplary listing of intermediate explain data. The intermediate explain data of FIG. 8 includes line numbers set forth in the left column of the data (802). Line 6 is displayed on more than one text line, for legibility, but it is still only one line of the explain data, as will be explained in more detail below.

The intermediate explain data of FIG. 8 encodes an access path for an SQL query for use in creating a visual representation by use of three record types. Record type ‘I’ indicates which icon to use in an element of graphic explain data. Record type ‘A; identifies text attributes of an element of graphic explain data. And record type ‘L’ represents links among elements of an access path. The syntax of each record type includes three elements: a first element identifying the record as type I, L, or A; a second element that stores an identification code for the element of an access path described by the record; and a third element dependent upon the first. That is, for I records, the third element is an icon identifier; for L records the third element is a link identification; and for A elements the third element is a set of text strings each of which is preceded by an indication of the length of the following string.

Therefore, line 1 of the illustrated intermediate explain data of FIG. 8, “I0 JOIN_ICON,” encodes and identifies an icon for a join element at level zero of the access path (708 on FIG. 7). Lines 2 and 3, “L 0 1” and “L 0 2,” identify respectively links from the element at level zero to elements identified as elements 1 and 2 (724 and 726 on FIG. 7). Line 4, “A 0 14 ‘Iterative Join,’” encodes as a 14 character string the additional explain data (706 on FIG. 7) for the zeroth element of the access path.

Line 5, “I 1 TABLE_SCAN_ICON,” is a second icon record, the one encoding the tablescan of the stores table (710 on FIG. 7). Line 6 is actually one line of intermediate explain data, which may represented thus:
A 1 20 “Table Scan of Stores” 28 “Cumulative Time (ms) 365.822” 20 “CPU Cost (ms) 473.62” 21 “I/O Cost (ms) 362.324” 14 “I/O Count 8241”
   which clarifies that the syntax of the ‘A’ record is:
A N number text number text number text number text
   where A is the record type, N is the identifier for the element of the access path, ‘number’ is the number of characters in the text string follow the number, and ‘text’ is a text string. Notice that line 6, in addition to encoding the explain text for the table scan (702), also encodes the tooltip data (716 on FIG. 7) for the tablescan of the stores table.

Line 7, “I2 INDEX_PROBE_ICON,” is a third icon record, the one encoding the index access of the transactions table (714 on FIG. 7). Line 8, “A 2 27 ‘Index Probe of Transactions,’” encodes as a 27 character string the additional explain data (704 on FIG. 7) for the index access element of the access path.

The encoding of intermediate explain data as described here with record types for icons, links, and attributes is an exemplary explanation of an encoding of intermediate explain data, not a limitation of the invention. Persons of skill in the art will recognize that such encoding may be implemented in a number of ways, including, for example, encoding with the eXtensible Markup Language (‘XML’), and all such ways are well within the scope of the present invention.

In view of the explanations and examples set forth above in this specification, readers of skill in the art will understand that the benefits of displaying explain data for an SQL query of a database according to embodiments of the present invention include:
elimination of any need for activation of a monitor or trace function before executing an SQL query in order to make explain data available for display, and
elimination of any need to wait for complete execution of an SQL query before displaying explain data for the query.

Exemplary embodiments of the present invention are described largely in the context of a fully functional computer system for displaying explain data for an SQL query of a database. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web. Persons skilled in the art will immediately recognize that any computer system having suitable programming means will be capable of executing the steps of the method of the invention as embodied in a program product. Persons skilled in the art will recognize immediately that, although most of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for displaying explain data for an SQL query of a database, the method comprising:
executing an SQL query; and
displaying explain data for the SQL query while executing the SQL query.

2. The method of claim 1 wherein displaying explain data further comprises:
identifying an access plan associated with the SQL query;
generating explain data in dependence upon the access plan.

3. The method of claim 2 wherein identifying an access plan further comprises:
retrieving an access plan identification from a cursor of a job control block; and
retrieving an access plan from an access plan cache in dependence upon the access plan identification.

4. The method of claim 2 wherein generating explain data further comprises:
generating an intermediate representation of the access plan as intermediate explain data; and
generating a graphic representation of the access plan in dependence upon the intermediate explain data.

5. The method of claim 1 wherein executing the SQL query further comprises:
creating an access plan for the SQL query; and
executing primitive query functions in dependence upon the access plan.

6. The method of claim 5 wherein creating the access plan further comprises:
parsing the SQL query; and
creating the access plan in dependence upon the parsed query.

7. The method of claim 5 wherein creating the access plan further comprises optimizing the access plan in dependence upon database management statistics.

8. An apparatus for displaying explain data for an SQL query of a database, the apparatus comprising:
a computer processor;
a computer memory coupled for data transfer to the processor, the computer memory having disposed within it computer program instructions comprising:
an SQL module capable of executing an SQL query; and
an explain module capable of displaying explain data for the query while executing the query.

9. The apparatus of claim 8 wherein the explain module further comprises:
an access plan identifier capable of identifying an access plan associated with the query;
an explain data generator capable of generating explain data in dependence upon the access plan.

10. The apparatus of claim 9 wherein the access plan identifier further comprises:
an access plan identification retriever capable of retrieving an access plan identification from a cursor of a job control block; and
an access plan retriever capable of retrieving an access plan from an access plan cache in dependence upon the access plan identification.

11. The apparatus of claim 9 wherein the explain data generator further comprises:
an intermediate generator capable of generating an intermediate representation of the access plan as intermediate explain data; and
a graphics generator capable of generating a graphic representation of the access plan in dependence upon the intermediate explain data.

12. The apparatus of claim 8 wherein the SQL module further comprises:
an access plan generator capable of creating an access plan for the SQL query; and
a primitives engine capable of executing primitive query functions in dependence upon the access plan.

13. The apparatus of claim 12 wherein the access plan generator further comprises:
a parser for parsing the SQL query;
wherein the access plan generator is further capable of creating the access plan in dependence upon a parsed query.

14. The apparatus of claim 12 wherein access plan generator further comprises an optimizer capable of optimizing the access plan in dependence upon database management statistics.

15. A system for displaying explain data for an SQL query of a database, the system comprising:
means for executing an SQL query; and
means for displaying explain data for the query while executing the query.

16. The system of claim 15 wherein means for displaying explain data further comprises:
means for identifying an access plan associated with the query;
means for generating explain data in dependence upon the access plan.

17. The system of claim 16 wherein means for identifying an access plan further comprises:
means for retrieving an access plan identifier from a cursor of a job control block; and
means for retrieving an access plan from an access plan cache in dependence upon the access plan identifier.

18. The system of claim 16 wherein means for generating explain data further comprises:
means for generating an intermediate representation of the access plan as intermediate explain data; and
means for generating a graphic representation of the access plan in dependence upon the intermediate explain data.

19. The system of claim 15 wherein means for executing the SQL query further comprises:
means for creating an access plan for the SQL query; and
means for executing primitive query functions in dependence upon the access plan.

20. The system of claim 19 wherein means for creating the access plan further comprises:
means for parsing the SQL query; and
means for creating the access plan in dependence upon the parsed query.

21. The system of claim 19 wherein means for creating the access plan further comprises means for optimizing the access plan in dependence upon database management statistics.

22. A computer program product for displaying explain data for an SQL query of a database, the computer program product disposed upon a signal bearing medium, the computer program product comprising:
computer program instructions that execute an SQL query; and
computer program instructions that display explain data for the query while executing the query.

23. The computer program product of claim 22 wherein the signal bearing medium comprises a recordable medium.

24. The computer program product of claim 22 wherein the signal bearing medium comprises a transmission medium.

25. The computer program product of claim 22 wherein computer program instructions that display explain data further comprise:
computer program instructions that identify an access plan associated with the query;
computer program instructions that generate explain data in dependence upon the access plan.

26. The computer program product of claim 25 wherein computer program instructions that identify an access plan further comprise:
computer program instructions that retrieve an access plan identifier from a cursor of a job control block; and
computer program instructions that retrieve an access plan from an access plan cache in dependence upon the access plan identifier.

27. The computer program product of claim 25 wherein computer program instructions that generate explain data further comprise:
computer program instructions that generate an intermediate representation of the access plan as intermediate explain data; and
computer program instructions that generate a graphic representation of the access plan in dependence upon the intermediate explain data.

28. The computer program product of claim 22 wherein computer program instructions that execute the SQL query further comprise:
computer program instructions that create an access plan for the SQL query; and
computer program instructions that execute primitive query functions in dependence upon the access plan.

29. The computer program product of claim 28 wherein computer program instructions that create the access plan further comprise:
computer program instructions that parse the SQL query; and
computer program instructions that create the access plan in dependence upon the parsed query.

30. The computer program product of claim 28 wherein computer program instructions that create an access plan further comprise computer program instructions that optimize the access plan in dependence upon database management statistics.
